(19) United States
(12) Patent Application Publication
(10) Pub. No.: US 2009/0107054 A1
(43) Pub. Date: Apr. 30, 2009

(54) GARAGE DOOR WINDOW DECORATION METHOD

(76) Inventor: Laddie Waller, Oceanside, CA (US)

Correspondence Address: STEVEN W. WEBB, 825 College Blvd., Suite 102620, Oceanside, CA, 92057, US

(21) Appl. No.: 11/924,854

(22) Filed: Oct. 26, 2007

(51) Int. Cl. G09F 7/18; E04G 17/02

(52) U.S. Cl. 52/38; 52/745.16

(57) ABSTRACT

A system and method for decorating roll-up garage doors with unique designs is presented. The system permits special messages or seasonal decorations to be easily inserted and removed/replaced as the homeowner wishes. The system provides decorations to fit all roll-up garage door window sizes and shapes.

### FIELD OF THE INVENTION

The present invention relates to the field of window coverings. More particularly, the present invention relates to a specialized window cover especially useful for roll-up garage doors for automobile garages. Such doors often have a row of windows across the width of the door broken up into narrow or wide panels. The present invention provides a decorative covering for such garage door windows carrying a special message or a particular decoration, which can be related to special events, holidays, or the like.

### BACKGROUND OF THE INVENTION

There are several window coverings taught in the prior art. These include window shades which are used to cover window panes, fabric window coverings and hardware for hanging in windows.

Roll-up garage door windows generally come in rectangular shapes. It is well known to add a design treatment to a rectangular or square type roll-up garage door window to add a bit of decoration to the door. Classic geometric patterns, such as diamonds, triangles, sunrises, and the like are available at door installation time.

However, the prior art does not teach a garage door window treatment system that is removable by the homeowner and replaceable with a subsequent design, including words and other non-geometric designs, such as snowflakes or pumpkins, and the like.

### SUMMARY OF THE INVENTION

The objectives of the present invention are to provide a removable and replaceable window covering treatment system which is easily fabricated and can be mounted by the homeowner in typical window panes found in the garage doors. The system of the present invention utilizes prefabricated plastic moldings. The window covering of the present invention can be mounted principally by a system attaching the covering to the window by a hook and loop fastening system.

Other capabilities of the invention will become apparent from the detailed specification in combination with the accompanying drawings showing preferred embodiments of the invention.

### BRIEF DESCRIPTION OF THE DRAWINGS

FIG. 1 is a front view of a roll-up garage door, showing the windows with the design “MERRY XMAS” attached

FIG. 2 is a top view of the frame of the present invention with tabs without a figure or pattern

FIG. 3 is a top view of the frame of the present invention with a continuous rim in place of tabs around it

FIG. 4 is a cross-section of the “double sticky” window attachment means

### DESCRIPTION OF THE PREFERRED EMBODIMENT

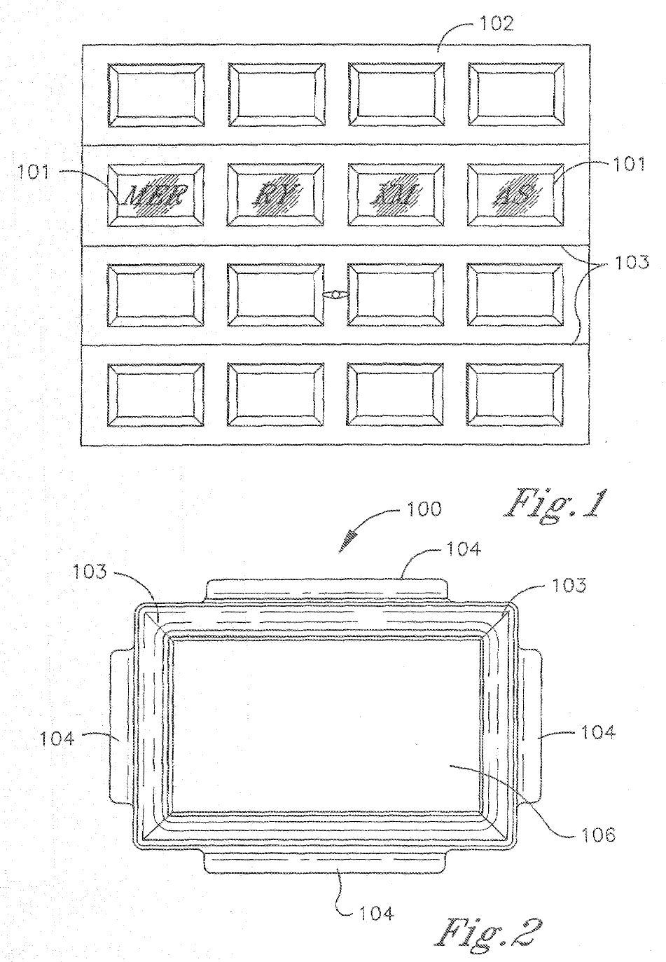

The present invention 100 installed in a series of garage door windows 101 is shown in FIG. 1. The garage door 102 folds along the horizontal seams 103 as it is rolled up and rolled down.

The design “MER RY XM AS” is shown in the four horizontally-arranged windows 101. This is a typical pattern of garage door windows; there are garage doors that have eight smaller windows arranged horizontally, not shown. The present invention can be sized to fit each of these window types.

FIG. 2 shows the invention 100 with a raised frame 103 and attachment tabs 104. The frame 103 can be filled with any decorative figure or lettering, such as shown in FIG. 1.

FIG. 3 shows a top view of the preferred embodiment of the invention, with raised frame 103 and a continuous rim 105 that extends around the frame 103.

The invention 100 is made by pressure forming a sheet of stiff plastic material, and results in a thin, continuous sheet that is curved and raised from the plane of the original sheet before forming. The frame 103 is raised from the plastic material by means of the pressure forming, and patterns and designs can be formed, cut, or stenciled into the interior of the frame 106.

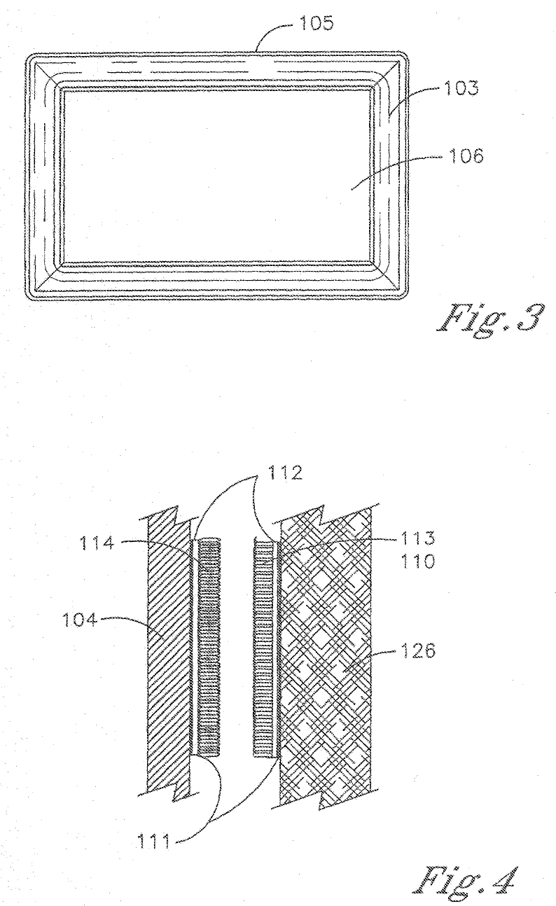

As shown in FIG. 4, the means of attachment for this invention is designed to enable the homeowner to quickly and easily place, remove, and replace the invention in the windows 101 of his garage doors 102. The attachment means of the preferred embodiment consists of “double sticky” connectors 110, which can be cut to a desired size to fit the rim 105 or tabs 104.

The “double sticky” connector 110 is comprised of two layers of adhesive 111, two backing layers 112, and a set of hooks 113 and loops 114. The tabs 104 and rim 105 of the two embodiments are flat as they extend away from the frame 103. The underside of the tabs 104 or rim 105 of the invention 100 is used to place one side of the “double sticky” connector 110 and the garage door window 101 surface is used to place the other side of the connector 110.

To assemble and use the invention 100, as shown in FIG. 4, the hooks 113 and loops 114 are separated, the loops side 120 of the connector 110 is attached to the underside 125 of either the tab 104 or rim 105 of the invention by means of the adhesive layer 111, the hooks side 121 of the connector 110 is attached to the surface 126 of the garage door window 101 by means of the adhesive layer, and then the underside of the invention 100 is pressed against the surface of the window 101 and because of the placement of the the two parts of the connector 110, the hooks 113 and loops 114 grab each other and hold the invention 100 to the window surface 126.

This invention has other applications, potentially, and one skilled in the art could discover these. The explication of the features of this invention does not limit the claims of this application; other applications developed by those skilled in the art will be included in this invention.

What is claimed is:

1. a window decoration system, the system comprised of
a window decoration frame and a connection means, p1 the window decoration frame comprised of a frame, a decoration area, and an attachment rim,
the window decoration frame in a generally rectangular shape with a planar orientation, the frame surrounding the decoration area, the attachment rim surrounding the frame continuously and extending beyond the edge of the frame,
the attachment rim comprised of either a sequence of tabs or a continuous rim,
the decoration are containing any flat decoration that can be produced by cutting of material or stenciling such that light will pass through the decoration,
the connection means a means of attaching the window decoration frame to a window surface,
the connection means comprised of a sheet of hook and loop connectors, the sheet of hook and loop connectors comprised of two flat backing layers with one backing layer possessing hooks on one side and the other backing layer possessing loops on one side, the other side of each of the backing layers possessing a layer of adhesive.

2. A method of using a window decoration system as in claim 1, comprised of the steps of
obtaining the desired shape and size of window decoration frame with the desired decoration in the decoration area,
cutting and trimming one or more sheets of the connection means to the desired size and shape,
separating the hooks and lops of the connection means,
attaching the loop portions of the connection means to the underside of the attachment rim at strategic places by means of the adhesive layer of the loop portion of the connection means,
attaching the hook portions of the connection means to the surface of the window to be decorated in corresponding positions to the placement of the loop portions on the invention,
connecting the window decoration system to the window by means of bring the hook portions and the loop portions of the connection means together.
